(19) United States
(12) Patent Application Publication
(10) Pub. No.: US 2005/0023029 A1
(43) Pub. Date: Feb. 3, 2005

(54) Flame-resistant cable

(76) Inventors: Mohammed Mammeri, Paron (FR); Raymond Petrus, Moncourt Fromonville (FR); Bernard Poisson, Sens (FR); Gwenaelle Raoult, Auxy (FR)

Correspondence Address: BIRCH STEWART KOLASCH & BIRCH, PO BOX 747, FALLS CHURCH, VA, 22040-0747, US

(21) Appl. No.: 10/901,099

(22) Filed: Jul. 29, 2004

(30) Foreign Application Priority Data
Aug. 1, 2003 (FR) 0309515

(51) Int. Cl. H01B 7/00

(52) U.S. Cl. 174/121 A

(57) ABSTRACT

The flame-resistant electric cable comprising at least one central conductor surrounded by an insulating layer, itself surrounded by an outer sheath comprising an inner layer of flame-resistant synthetic material that conserves mechanical stability when it is subjected to a source of heat leading to softening, and an outer layer of a flame-resistant synthetic material in contact with the inner layer and decomposing into a thermally insulating layer when it is subjected to a source of heat leading to its decomposition.

The present invention relates to a flame-resistant cable.

### BACKGROUND OF THE INVENTION

For many years it has been known that in order to avoid risks of fire propagating, in particular in public places, it is desirable to make electric cables flame resistant.

For low-voltage cables which are generally very simple in structure comprising one or more conductors each surrounded by an insulating layer and covered an outer sheath, the cable is generally made flame resistant by causing the insulating layer and in the outer sheath to incorporate flame-resistant fillers such as aluminum hydroxide or magnesium hydroxide which decompose at high temperatures to produce water.

Given the increasing power of electricity distribution networks due to the increasing amount of electrical equipment running on electricity in public places, it is now necessary to bring in electricity at medium voltage or even at high voltage into town centers before transforming it to low voltage.

It is therefore necessary to ensure that medium-voltage or high-voltage cables are flame resistant. Unfortunately, incorporating flame-resistant fillers in the insulation of cables diminishes their insulating characteristics, which means that it is not possible to envisage incorporating flame-resistant fillers into the insulating layer of a medium-voltage or a high-voltage cable. The insulating layer of such a cable thus constitutes a potential source of fire propagation.

The risk of fire propagating is particularly high for nigh-voltage cables which generally comprise, between the conductor and the insulating layer, and also between the insulation and a metal shield of the cable, layers that serve to reduce electrical stresses, which layers essentially comprise an olefin polymer made conductive by a large quantity of carbon black so that, together with the insulation, they constitute a dangerous fuel in the event of a fire.

In practice, medium-voltage or high-voltage cables are made flame-resistant by incorporating flame-resistant fillers in the outer sheath only. Amongst prior art cables, the sheath is constituted by olefin polymers such as ethylene vinyl acetate (EVA), ethylene butyl acrylate (EBA), ethylene-ethyl acrylate (EEA), ethylene-methyl acrylate (EMA), ethylene propylene rubber (EPR), ethylene propylene diene (EPDM), and very low density polyethylene (VLDPE), which are used either in cross-linked form or in thermoplastic form. Cross-linked materials such as those described in particular in U.S. Pat. No. 3,979,356 present the advantage of conserving good mechanical stability when they are subjected to a source of heat, because of the three-dimensional lattice created by the cross-linking. Such materials therefore have little tendency to swell under the effect of high temperature and remain pressed against the underlying layer. Nevertheless, specifically because of this mechanical stability, cross-linked materials are poor thermal insulators, such that prolonged exposure of the cable to a source of heat rapidly leads to the underlying insulating layer melting, and its weight then runs the risk of causing the outer sheath to burst, thereby releasing a highly combustible liquid from the cable and leading to instantaneous propagation of the fire.

In contrast, thermoplastic materials such as those described in particular in document JP 2 189 809 decompose at high temperature with a large amount of expansion such that the ash formed after local combustion of the thermoplastic sheath constitutes a thick layer of ash which has considerable thermal insulation power and which therefore protects the underlying layers against a fast rise in temperature. Nevertheless, the initial expansion of the thermoplastic layer considerably reduces its mechanical stability and there therefore exists a significant risk of the sheath breaking up, with fragments of it dropping away so that the flames can then come directly into contact with the underlying layers of the cable.

Naturally, it would be possible to achieve a sufficient degree of protection of the flammable layers of the cable by increasing the thickness of the outer sheath. Nevertheless, that raises problems of expense not only during manufacture of the cable but also when laying it because of the size and the weight of a cable with a thick sheath.

In order to avoid increasing the thickness of the outer sheath, proposals have also made for it to be implemented in the form of two layers of thermoplastic material separated by a holding sheet of fiberglass. Such a structure nevertheless leads to an increase in the cost of manufacturing the cable. In addition, in order to achieve effective holding, the holding sheet of fiberglass must itself be of sufficient thickness, thereby increasing the stiffness of the cable and thus making it more difficult to handle.

### OBJECT OF THE INVENTION

An object of the invention is to make an electric cable flame resistant in which the insulating layer of the cable is not flame resistant, while minimizing the secondary effects of such fireproofing.

### BRIEF SUMMARY OF THE INVENTION

In order to achieve this object, the invention provides a flame-resistant electric cable comprising at least one central conductor surrounded by an insulating layer itself surrounded by an outer sheath comprising an inner layer of flame-resistant synthetic material that conserves mechanical stability when it is subjected to a source of heat leading to softening, and an outer layer of a flame-resistant synthetic material in contact with the inner layer and decomposing into a thermally insulating layer when it is subjected to a source of heat leading to its decomposition.

Thus, it has been found, surprisingly, that compared with a uniform sheath of determined thickness, the sheath structure of the invention makes it possible for the same total thickness of sheath to obtain significantly reinforced protection against fire.

According to advantageous aspects of the invention, the inner layer of the outer sheath is made of cross-linked polymer and the outer layer of the outer sheath is made of a thermoplastic polymer that expands on decomposing. Thus, the structure of the invention is obtained by using known components whose behavior during cable manufacture is well understood.

### BRIEF DESCRIPTION OF THE DRAWING

Other characteristics and advantages of the invention will appear on reading the following description of a particular and non-limiting embodiment of the invention, given with reference to the sole accompanying figure which is a section view of a cable of the invention.

### DETAILED DESCRIPTION OF THE INVENTION

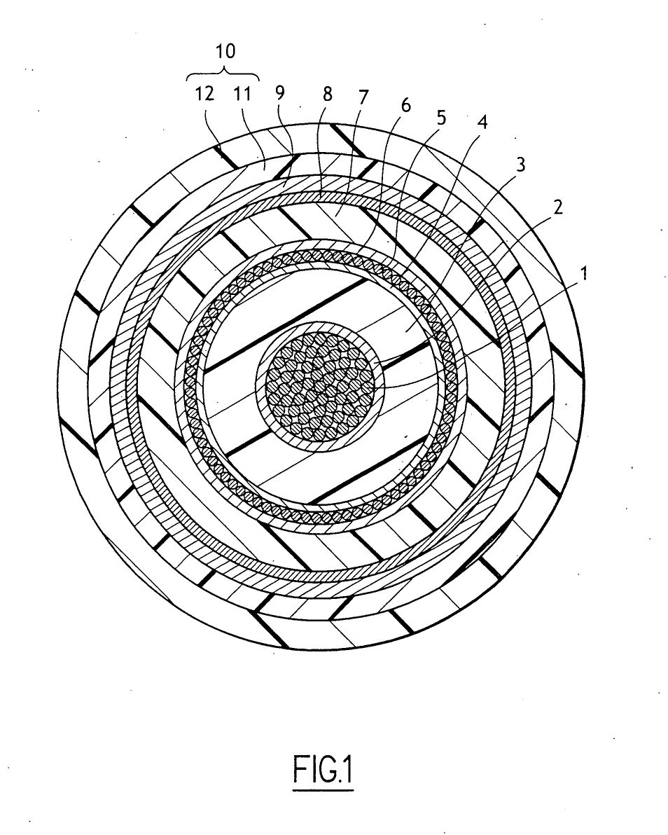

With reference to FIG. 1, the cable of the invention is shown with the thicknesses of its layers deliberately out of proportion compared with reality in order to facilitate understanding. The cable shown comprises in conventional manner a central conductor 1 made up of copper wires that are twisted together. The central conductor is surrounded in succession by a layer 2 for reducing electrical stress, an insulating layer 3, a second layer 4 for reducing electrical stress, a second electrical conductor 5 constituted by a sheet of copper wires wound helically, a third layer 6 for reducing electrical stress, a second insulating layer 7, a fourth layer 8 for reducing electrical stress, a metal shield 9 constituted by a helically-wound copper tape, and an outer sheath 10 in contact with the metal shield 9.

In accordance with the invention, the outer sheath 10 comprises an inner layer 11 of a flame-resistant synthetic material that conserves mechanical stability when it is subjected to a source of heat that leads to softening, and an outer layer 12 of flame-resistant synthetic material in contact with the inner layer 11 and that decomposes into a thermal insulating layer when it is subjected to a source of heat that causes it to decompose. Typically, the inner layer 11 is made of an olefin copolymer such as EVA, EBA, EEA, or EMA having the usual quantities of flame-resistant fillers incorporated therein such as hydrated compounds based on aluminum hydroxide or on magnesia, or fillers suitable for giving off CO₂, e.g. magnesium carbonate, the copolymer being cross-linked after the flame-resistant fillers been incorporated using a conventional cross-linking technique such as peroxide-curing, silane-curing, or electron-beam curing. Typically, the outer layer 12 has the same composition as the inner layer 11, but it is not subjected to cross-linking so that it remains in a thermoplastic state even after being applied to the cable.

Comparative fire tests have been performed with a cable as defined above and with cables that differ therefrom solely in the structure of the outer sheath, the cable having a diameter of 42 millimeters (mm) and the outer sheath having a total thickness of 4 mm.

A first test was performed with a cable comprising a uniform outer sheath with a thickness of 4 mm made of a thermoplastic material identical to that of the outer layer 12. In accordance with the standard in force for fire testing, six segments of cable each having a length of 3.5 meters (m) were disposed vertically on a test ladder, being spaced apart by 20 mm, facing two 20 kilowatt (kW) burners at a distance of 75 mm from the sheet of cables. In accordance with the standard, the burners were actuated for 40 minutes (min). After 30 min, the height of the flames had already reached 1.5 m, and at the end of the test the sheet of cables had been totally destroyed, the outer sheath having collapsed during the test.

A second test was performed with similar segments of cable, but having an outer sheath of uniform composition of a material identical to that of the inner layer 11 and having a thickness of 4 mm. During the test, the sheath swelled moderately and remained pressed against the shield, the flame reaching a height of about 2 m at the end of the test. Nevertheless, after the burners were turned off, the cable continued to burn until the sheet of cables was completely destroyed. An analysis of the sheet of cables after the flames had been extinguished showed that both insulating layers had been totally destroyed.

A third test was performed with a cable having an outer sheath 10 in accordance with the invention comprising a cross-linked inner layer 11 with a thickness of 2.5 mm and a thermoplastic outer layer 12 with a thickness of 1.5 mm. During the test, the flames reached a maximum height of 90 centimeters (cm). When the burners were turned off, the flames immediately began to decrease and went out after about 15 min. After the flames had extinguished, it was found that the cable was destroyed over a height of only 80 cm, and the inner insulation over a height of only 50 cm, whereas according to the standard, a cable is deemed to have sufficient ability to withstand fire for a destroyed height of up to 2.5 m.

A test was also performed with the cable of the invention on the opaqueness of the smoke given off, and at the end of that test, it was found that light transmission was greater than 90%, whereas according to the standard that is in force, the cable is compliant providing light transmission is greater than 60% at the end of the test. The cable of the invention thus has fire-resistant properties that are considerably better than those required by the standards in force.

Naturally, the invention is not limited to the embodiment described and variants can be applied thereto without going beyond the ambit of the invention as defined by the claims.

In particular, although the invention is described above with respect to a cable having two conductors and a metal shield surrounding the second insulating layer, the invention can be applied to a cable having a single conductor, with or without a metal shield.

Although the invention is described with reference to an outer sheath in which the inner layer has a thickness that is equal to 60% of the total thickness of the outer sheath, it is possible for the thickness distribution of the two layers to be different, although it is nevertheless preferable for the inner layer to be of a thickness that is not less than half the total thickness of the outer sheath.

Although the invention is described above with reference to an outer sheath comprising an olefin polymer including hydrated flame-resistant fillers, it is also possible to perform the invention with other synthetic materials and to provide additional flame-resistant fillers, such as, and additives that are useful for fabrication purposes such as anti-oxidants, lubricants, coupling agents, plasticizing agents, or agents serving to distinguish cables in use, such as coloring agents.

1. A flame-resistant electric cable comprising at least one central conductor surrounded by an insulating layer, itself surrounded by an outer sheath, wherein the outer sheath comprises an inner layer of flame-resistant synthetic material that conserves mechanical stability when it is subjected to a source of heat leading to softening, and an outer layer of a flame-resistant synthetic material in contact with the inner layer and decomposing into a thermally insulating layer when it is subjected to a source of heat leading to its decomposition.

2. A cable according to claim 1, wherein the inner layer of the outer sheath is made of cross-linked polymer.

3. A cable according to claim 1, wherein the outer layer of the outer sheath is made of a thermoplastic polymer that expands on being decomposed by heat.

4. A cable according to claim 1, wherein the thickness of the inner layer of the outer sheath is not less than half the total thickness of the outer sheath.

5. A cable according to claim 4, wherein the thickness of the inner layer of the outer sheath is equal to 60% of the total thickness of the outer sheath.

6. A cable according to claim 1, including a metal shield and wherein the inner layer of the outer sheath is in contact with the metal shield.
